(19) United States
(12) Patent Application Publication
(10) Pub. No.: US 2025/0100075 A1
(43) Pub. Date: Mar. 27, 2025

(54) SYSTEMS AND METHODS FOR METHOD FOR CREATING A CATHODE ELECTRODE PRODUCT FOR A BATTERY SYSTEM OF AN ELECTRIC VEHICLE

(71) Applicant: GM Global Technology Operations LLC, Detroit, MI (US)

(72) Inventors: James Joseph Deininger, Wyandotte, MI (US); Bradley R. Frieberg, Farmington Hills, MI (US); Roland J. Koestner, Plymouth, MI (US); Raffaello Ardanese, Bloomfield Hills, MI (US)

(73) Assignee: GM Global Technology Operations LLC, Detroit, MI (US)

(21) Appl. No.: 18/474,401

(22) Filed: Sep. 26, 2023

(51) Int. Cl. B23K 26/064; H01M 4/02; H01M 4/04

(52) U.S. Cl. CPC B23K 26/064; H01M 4/0404; H01M 2004/028; H01M 2220/20

(57) ABSTRACT

A system comprises a donor foil, a carrier substrate disposed adjacent the donor foil, an optical system configured to generate a laser beam through the donor foil and the carrier substrate to create a plurality of cathode voxels, and a current collector foil defined by an X-Y plane and configured to collect the plurality of cathode voxels in the X-Y plane, wherein a first set of the plurality of cathode voxels at a first location on the X-Y plane are diluted with a first amount of a solvent and a second set of the plurality of cathode voxels at a second location on the X-Y plane are diluted with a second amount of a solvent, the second amount of the solvent being less than the first amount of the solvent.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to systems and methods for creating a cathode electrode product for a battery system of an electric vehicle. The present disclosure applies an Electrode Laser Induced Forward Electrode Transfer (eLIFT) process, and eLIFT formulations, to create a cathode electrode product that can be utilized for electric battery development, validation, and standardization across the automotive industry.

The eLIFT printing process creates unique surface geometry and roughness designs using customized combinations of both multiple eLIFT printing parameters, and density of the cathode formulation to create a unique eLIFT formulation.

The eLIFT electrode product may be easily detectable through profilometer-microscopy methods due to the ability to create unique surface geometries through the customized combinations. These unique combinations give one the ability to control surface geometry with a much higher degree compared to roll-to-roll.

Other conventional methods such as roll-to-roll (R2R) have difficulty achieving such architectures with high reproducibility. Furthermore, other additive manufacturing process such as extrusion or ink-jet printing make it difficult to create battery electrodes due to inherent process limitations on material properties such as viscosity and particle size making many electrode materials difficult to use in a printing process.

Accordingly, there is room for improvement of system and methods with fewer limitations and greater potential for high-speed deposition.

### SUMMARY

One aspect of the disclosure provides a system comprising a donor foil, a transparent carrier substrate disposed adjacent the donor foil, an optical system configured to generate a laser beam through the donor foil and the transparent carrier substrate to create a plurality of cathode voxels, and a current collector foil defined by an X-Y plane and configured to collect the plurality of cathode voxels in the X-Y plane, wherein a first set of the plurality of cathode voxels at a first location on the X-Y plane have a first thickness in a Z-direction perpendicular to the X-Y plane and a second set of the plurality of cathode voxels at a second location on the X-Y plane have a second thickness in the Z-direction, the second thickness in the Z-direction being less than the first thickness in the Z-direction.

Implementations of the disclosure may include one or more of the following optional features. In some implementations, the first set of the plurality of cathode voxels are spaced from the second set of the plurality of cathode voxels along the X-Y plane.

The first set of the plurality of cathode voxels may at least partially overlap with the second set of the plurality of cathode voxels along the X-Y plane.

The first set of the plurality of cathode voxels may be diluted with a solvent in a range of 0-20% of the total composition of each voxel of the first set of the plurality of cathode voxels. The second set of the plurality of cathode voxels may be diluted with a solvent in a range of 0-20% of the total composition of each voxel of the second set of the plurality of cathode voxels. The first set of the plurality of cathode voxels may be diluted with the solvent in an amount less than the second set of the plurality of cathode voxels are diluted with the solvent.

The first set of the plurality of cathode voxels may include a first subset of cathode voxels and a second subset of cathode voxels disposed along the same Z-axis as the first subset of cathode voxels, the first subset of cathode voxels being diluted with a solvent in an amount less than the second subset of cathode voxels are diluted with a solvent.

Another aspect of the disclosure provides a system comprising a donor foil, a carrier substrate disposed adjacent the donor foil, an optical system configured to generate a laser beam through the donor foil and the carrier substrate to create a plurality of cathode voxels, and a current collector foil defined by an X-Y plane and configured to collect the plurality of cathode voxels in the X-Y plane, wherein a first set of the plurality of cathode voxels at a first location on the X-Y plane are diluted with a first amount of a solvent and a second set of the plurality of cathode voxels at a second location on the X-Y plane are diluted with a second amount of a solvent, the second amount of the solvent being less than the first amount of the solvent.

Implementations of the disclosure may include one or more of the following optional features. In some implementations, the first set of the plurality of cathode voxels are spaced from the second set of the plurality of cathode voxels along the X-Y plane.

The first set of the plurality of cathode voxels may at least partially overlap with the second set of the plurality of cathode voxels along the X-Y plane.

The first set of the plurality of cathode voxels may be diluted with the solvent in a range of 0-20% of the total composition of each voxel of the first set of the plurality of cathode voxels. The second set of the plurality of cathode voxels may be diluted with the solvent in a range of 0-20% of the total composition of each voxel of the second set of the plurality of cathode voxels.

The plurality of cathode voxels may be configured for use in a battery system of an electric vehicle.

Another aspect of the disclosure provides a method for creating a cathode electrode product for a battery system of an electric vehicle, the method comprising providing a donor foil, providing a carrier substrate disposed adjacent the donor foil, providing an optical system, providing a current collector foil defined by an X-Y plane, activating the optical system to generate a laser beam through the donor foil and the carrier substrate to create a plurality of cathode voxels, and collecting the plurality of cathode voxels on the current collector foil.

Implementations of the disclosure may include one or more of the following optional features. In some implementations, the plurality of cathode voxels includes a first set of cathode voxels and a second set of cathode voxels. The first set of the plurality of cathode voxels may be spaced from the second set of the plurality of cathode voxels along the X-Y plane.

The first set of the plurality of cathode voxels may at least partially overlap with the second set of the plurality of cathode voxels along the X-Y plane.

The first set of the plurality of cathode voxels may be diluted with the solvent in a range of 0-20% of the total composition of each voxel of the first set of the plurality of cathode voxels.

The second set of the plurality of cathode voxels may be diluted with the solvent in a range of 0-20% of the total composition of each voxel of the second set of the plurality of cathode voxels.

The plurality of cathode voxels may be configured for use in a battery system of an electric vehicle.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic diagram of an eLIFT cathode system in accordance with the principles of the present disclosure;

FIG. 2 is a schematic diagram of a portion of the eLIFT cathode system of FIG. 1 and the resultant cathode product;

FIG. 3A is a schematic diagram of a first exemplary cathode product created by the eLIFT cathode system of FIG. 1;

FIG. 3B is a schematic diagram of a second exemplary cathode product created by the eLIFT cathode system of FIG. 1;

FIG. 3C is a schematic diagram of a third exemplary cathode product created by the eLIFT cathode system of FIG. 1;

FIG. 3D is a schematic diagram of a fourth exemplary cathode product created by the eLIFT cathode system of FIG. 1;

FIG. 3E is a schematic diagram of a fifth exemplary cathode product created by the eLIFT cathode system of FIG. 1;

FIG. 3F is a schematic diagram of a sixth exemplary cathode product created by the eLIFT cathode system of FIG. 1;

FIG. 3G is a schematic diagram of a seventh exemplary cathode product created by the eLIFT cathode system of FIG. 1;

FIG. 3H is a schematic diagram of an eighth exemplary cathode product created by the eLIFT cathode system of FIG. 1;

FIG. 4A is a topographic diagram of a ninth exemplary cathode product created by the eLIFT cathode system of FIG. 1;

FIG. 4B is a topographic diagram of a tenth exemplary cathode product created by the eLIFT cathode system of FIG. 1;

FIG. 5A is a schematic diagram of a side view of a first exemplary column of cathode voxels crated by the eLIFT cathode system of FIG. 1;

FIG. 5B is a schematic diagram of a side view of a second exemplary column of cathode voxels crated by the eLIFT cathode system of FIG. 1;

FIG. 5C is a schematic diagram of a side view of a third exemplary column of cathode voxels crated by the eLIFT cathode system of FIG. 1;

FIG. 5D is a schematic diagram of a side view of a fourth exemplary column of cathode voxels crated by the eLIFT cathode system of FIG. 1;

FIG. 6 is a flowchart diagram of a method for operating the eLIFT cathode system of FIG. 1; and

FIG. 7 is a graph showing discharge capacity per cycle for slurry cathode voxels and 50% overlapping cathode voxels.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

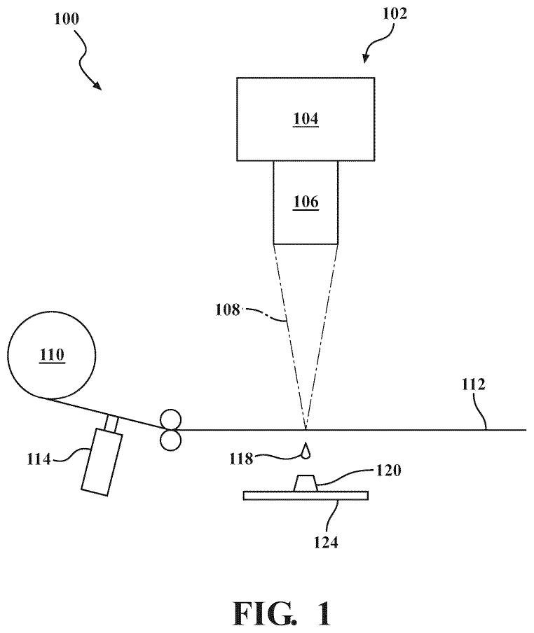

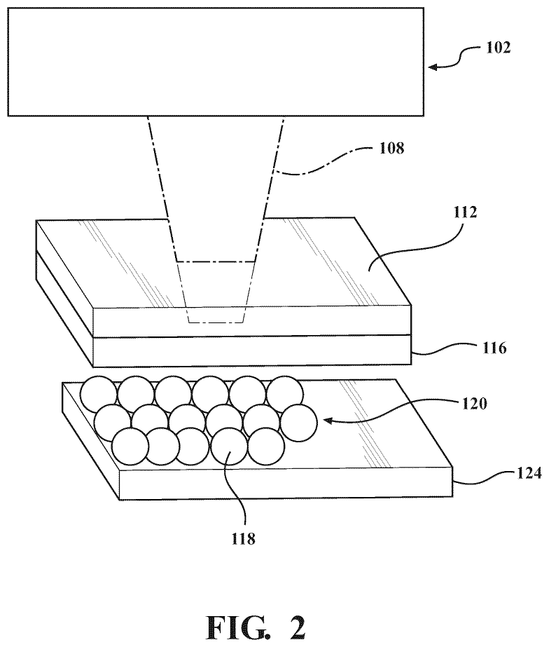

Referring to FIGS. 1 and 2, an Electrode Laser Induced Forward Electrode Transfer (eLIFT) cathode system 100 is generally shown. The eLIFT cathode system 100 includes an optical system 102 including an optical scanner 104 and optics 106 that are configured to generate and direct a laser beam 108.

The optical system 102 includes a controller comprising a computer system. The computer system of the controller includes a processor and a memory. The processor performs the computation and control functions of the controller and may comprise any type of processor or multiple processors, single integrated circuits such as a microprocessor, or any suitable number of integrated circuit devices and/or circuit boards working in cooperation to accomplish the functions of a processing unit. During operation, the processor executes one or more programs contained within the memory and, as such, controls the general operation of the controller and the computer system of the controller, generally in executing the processes described herein.

The memory may be any type of suitable memory. For example, the memory may include various types of dynamic random access memory (DRAM) such as SDRAM, the various types of static RAM (SRAM), and the various types of non-volatile memory (PROM, EPROM, and flash). In certain examples, the memory may be located on and/or co-located on the same computer chip as the processor.

The eLIFT cathode system 100 includes a donor foil roll 110 configured to contain a donor foil 112. In some implementations, the donor foil 112 may be transparent. The eLIFT cathode system 100 includes a dispenser 114 configured to provide a cathode material 116 (e.g., lithium-based material) adjacent the donor foil 112. In some implementations, the cathode material 116 is disposed below the donor foil 112. In other implementations, the cathode material 116 is disposed above the donor foil 112. In some implementations, the cathode material 116 may be diluted with a solvent in a range of between 0-20% of the total composition of the cathode material 116 and solvent.

The optical system 102 may generate the laser beam 108 through the donor foil 112 and the cathode material 116 to create a cathode voxel 118 that is received on a current collector foil 124, which defines an X-Y plane. Several cathode voxels 118 create a cathode product 120, as shown in FIGS. 1 and 2. The cathode product 120 can be created in with a variety of different densities, resolutions (e.g., overlapping of voxels), depositions, etc. The thickness of the cathode voxel layers can be controlled to tune the number of layers for a desired height allowing for more control of the density, porosity, and surface roughness that can lead to the tuning of electrochemical properties.

The cathode product 120 may be for a battery cell of an electric vehicle, which may be an automobile. As will be appreciated, the vehicle may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain configurations. The vehicle may also comprise a truck, a watercraft, an aircraft, and/or one or more other types of vehicles.

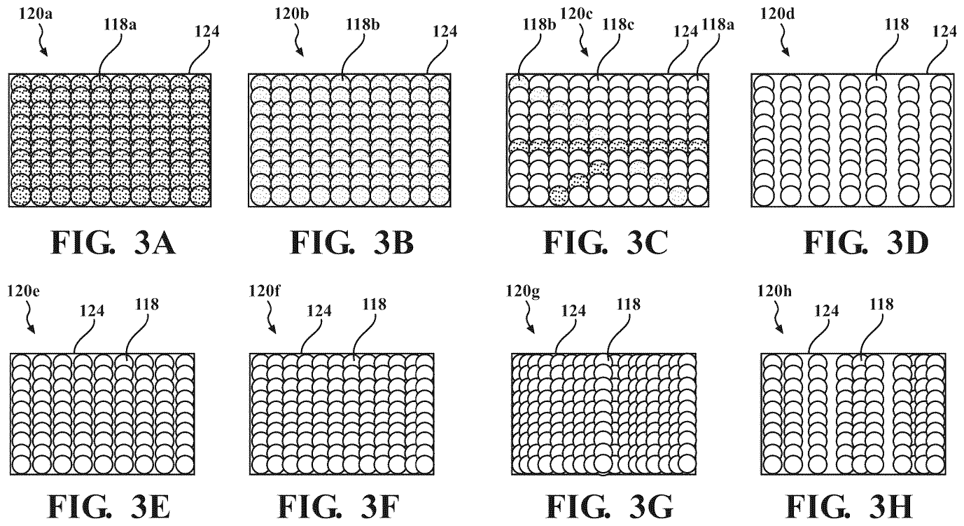

Referring to FIG. 3A, a first exemplary cathode product 120a is generally shown. The first exemplary cathode product 120a includes a series of first cathode voxels 118a without any dilution.

Referring to FIG. 3B, a second exemplary cathode product 120b is generally shown. The second exemplary cathode product 120b includes a series of second cathode voxels 118b including 10% dilution by the solvent.

Referring to FIG. 3C, a third exemplary cathode product 120c is generally shown. The third exemplary cathode product 120c includes the series of first cathode voxels 118a without any dilution, the series of second cathode voxels 118b including 10% dilution by the solvent, and a series of third cathode voxels 118c including 20% dilution by the solvent. As shown in FIG. 3C, the various cathode voxels 118a, 118b, 118c may be arranged in any suitable configuration.

Referring to FIG. 3D, a fourth exemplary cathode product 120d is generally shown. The fourth exemplary cathode product 120d includes the cathode voxels 118 arranged in rows along the X-Y plane that are spaced apart from one another.

Referring to FIG. 3E, a fifth exemplary cathode product 120e is generally shown. The fifth exemplary cathode product 120e includes the cathode voxels 118 arranged in rows along the X-Y plane that are less spaced apart from one another than the fourth exemplary cathode product 120d, thus, adjusting the resolution of the layer.

Referring to FIG. 3F, a sixth exemplary cathode product 120f is generally shown. The sixth exemplary cathode product 120f includes the cathode voxels 118 arranged in rows along the X-Y plane that are less spaced apart from one another than the fifth exemplary cathode product 120e. The cathode voxels 118 in the sixth exemplary cathode product 120f overlap one another, thus, adjusting the resolution of the layer.

Referring to FIG. 3G, a seventh exemplary cathode product 120g is generally shown. The seventh exemplary cathode product 120g includes the cathode voxels 118 arranged in rows along the X-Y plane that are less spaced apart from one another than the sixth exemplary cathode product 120f. The cathode voxels 118 in the seventh exemplary cathode product 120g overlap one another, thus, adjusting the resolution of the layer.

Referring to FIG. 3h, an eighth exemplary cathode product 120h is generally shown. The eighth exemplary cathode product 120h includes the cathode voxels 118 arranged in rows along the X-Y plane that are less spaced apart from one another than the seventh exemplary cathode product 120g. The cathode voxels 118 in the eighth exemplary cathode product 120h overlap one another, thus, adjusting the resolution of the layer.

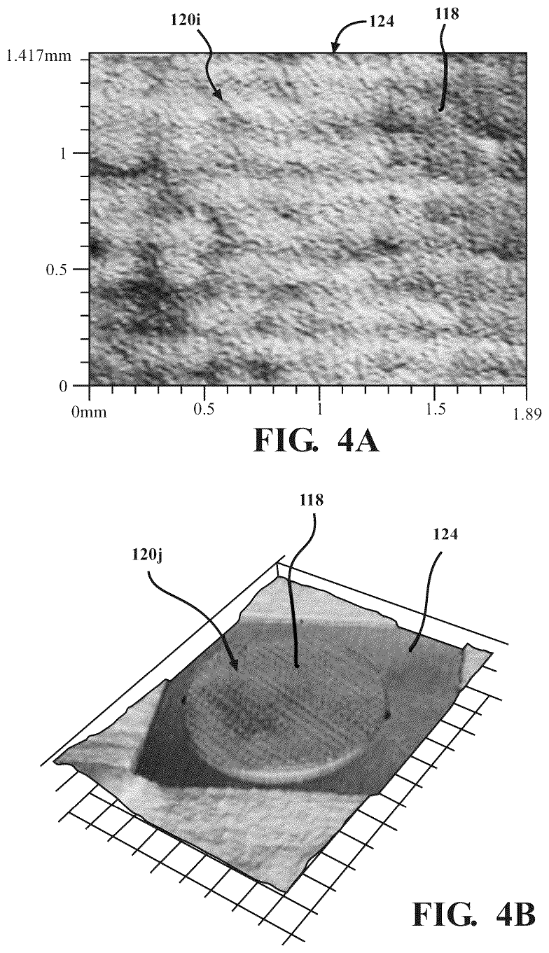

Referring to FIG. 4A, a ninth exemplary cathode product 120i is generally shown as a topographical view. A portion of the voxels 118 of the ninth exemplary cathode product 120i may have a greater height in the Z-direction at a first location than a portion of the voxels 118 at a second location.

Referring to FIG. 4B, a tenth exemplary cathode product 120j is generally shown as a topographical view. A portion of the voxels 118 of the tenth exemplary cathode product 120j may have a greater height in the Z-direction at a first location than a portion of the voxels 118 at a second location.

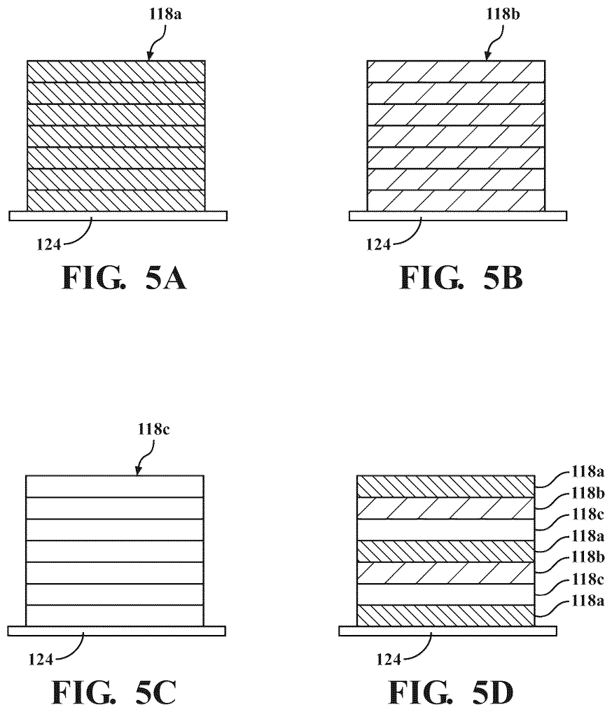

Referring to FIG. 5A, a side view of a column of the first voxels 118a is shown extending in the Z-direction. As shown, the first voxels 118a may include a height along the Z-direction.

Referring to FIG. 5B, a side view of a column of the second voxels 118b is shown extending in the Z-direction. As shown, the second voxels 118b may include a height along the Z-direction.

Referring to FIG. 5C, a side view of a column of the third voxels 118c is shown extending in the Z-direction. As shown, the third voxels 118c may include a height along the Z-direction.

Referring to FIG. 5D, a side view of a column of the first voxels 118a, second voxels 118b, and third voxels 118c is shown extending in the Z-direction. As shown, the first voxels 118a, second voxels 118b, and third voxels 118c may be arranged in any suitable configuration in the column to create a gradient voxel structure. For example, individual layers can have up to five different diluted cathode voxels 118 creating unique patterns or “gradient dilutions” within one layer.

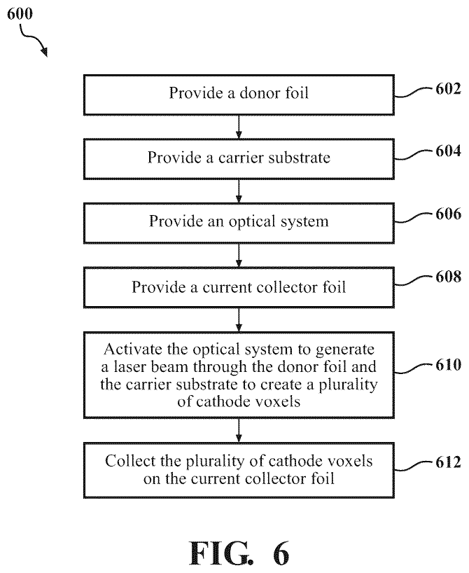

Referring to FIG. 6, a method 600 for operating the eLIFT cathode system 100 to create any of the aforementioned cathode products 120 is shown. The method 600 includes a first step 602 to provide the donor foil 112. The method 600 includes a second step 604 to provide a carrier substrate, e.g., the cathode material 116. The method 600 includes a third step 606 to provide the optical system 102. The method 600 includes a fourth step 608 to provide the current collector foil 124. The method 600 includes a fifth step 610 to activate the optical system 102 to generate the laser beam 108 through the donor foil 112 and the cathode material 116 to create the plurality of cathode voxels 118. The method 600 includes a sixth step 612 of collecting the plurality of cathode voxels 118 on the current collector foil 124 in any suitable configuration based on the desired density, resolution, porosity, surface roughness, etc.

Table 1 below illustrates the coating properties, electrochemical properties, and internal resistance for a slurry, 25% overlapping cathode voxels, 50% overlapping cathode voxels, and 75% overlapping cathode voxels.

TABLE 1

| | | | |
|---|---|---|---|
| | 25% | 50% | 75% |
| Slurry | Overlap | Overlap | Overlap |

Coating Properties

| | | | | |
|---|---|---|---|---|
| Average Loading (mg/cm2) | 25.5 | 22.9 | 27.2 | 22.9 |
| Average Thickness | 149 | 155 | 148 | 133 |
| as-received (um) | | | | |
| Porosity as-received (%) | 46.5 | 41.1 | 48.7 | 46.8 |
| Average Thickness pressed (um) | 99 | 91 | 103 | 89 |
| Porosity pressed (%) | 30 | 30 | 30 | 30 |
| Density (g/cm3) | 3.2 | 3.2 | 3.2 | 3.2 |

Electrochemical Properties

| | | | | |
|---|---|---|---|---|
| Capacity (@C/20, mAh/cm2) | 5.1 | 4.4 | 4.9 | 4.3 |
| Capacity (@C/20, mAh/g) | 200.3 | 195.8 | 191.7 | 193.8 |
| 1st Cycle C.E. (%) | 89.9 | 91.7 | 92.7 | 89.5 |

Internal Resistance

| | | | | |
|---|---|---|---|---|
| Thru-layer Electronic | 2.23 | 1.73 | 0.79 | 1.41 |
| Resistance (W-cm²) | | | | |
| SC-EIS Pore Channel | 1.91 | 1.99 | 1.73 | 2.30 |
| Tortuosity (l/l) | | | | |

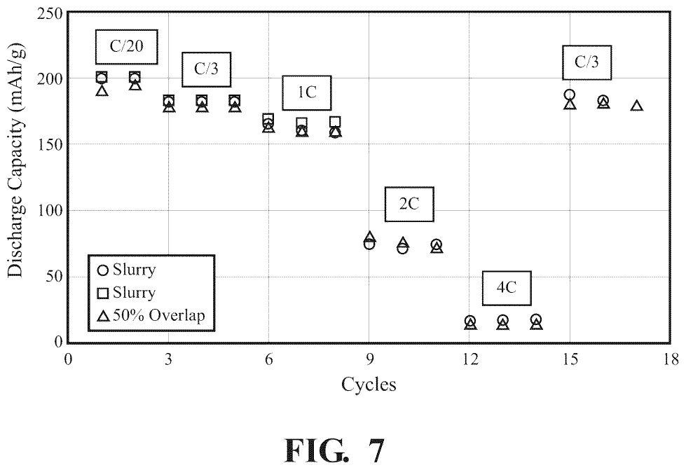

FIG. 7 illustrates the discharge capacity (mAh/g) per cycle for two kinds of slurries and 50% overlapping cathode voxels.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system comprising:
a donor foil;
a transparent carrier substrate disposed adjacent the donor foil;
an optical system configured to generate a laser beam through the donor foil and the transparent carrier substrate to create a plurality of cathode voxels; and
a current collector foil defined by an X-Y plane and configured to collect the plurality of cathode voxels in the X-Y plane, wherein a first set of the plurality of cathode voxels at a first location on the X-Y plane have a first thickness in a Z-direction perpendicular to the X-Y plane and a second set of the plurality of cathode voxels at a second location on the X-Y plane have a second thickness in the Z-direction, the second thickness in the Z-direction being less than the first thickness in the Z-direction.

2. The system of claim 1, wherein the first set of the plurality of cathode voxels are spaced from the second set of the plurality of cathode voxels along the X-Y plane.

3. The system of claim 1, wherein the first set of the plurality of cathode voxels at least partially overlap with the second set of the plurality of cathode voxels along the X-Y plane.

4. The system of claim 1, wherein the first set of the plurality of cathode voxels are diluted with a solvent in a range of 0-20% of the total composition of each voxel of the first set of the plurality of cathode voxels.

5. The system of claim 4, wherein the second set of the plurality of cathode voxels are diluted with a solvent in a range of 0-20% of the total composition of each voxel of the second set of the plurality of cathode voxels.

6. The system of claim 5, wherein the first set of the plurality of cathode voxels are diluted with the solvent in an amount less than the second set of the plurality of cathode voxels are diluted with the solvent.

7. The system of claim 1, wherein the first set of the plurality of cathode voxels includes a first subset of cathode voxels and a second subset of cathode voxels disposed along the same Z-axis as the first subset of cathode voxels, the first subset of cathode voxels being diluted with a solvent in an amount less than the second subset of cathode voxels are diluted with a solvent.

8. A system comprising:
a donor foil;
a carrier substrate disposed adjacent the donor foil;
an optical system configured to generate a laser beam through the donor foil and the carrier substrate to create a plurality of cathode voxels; and
a current collector foil defined by an X-Y plane and configured to collect the plurality of cathode voxels in the X-Y plane, wherein a first set of the plurality of cathode voxels at a first location on the X-Y plane are diluted with a first amount of a solvent and a second set of the plurality of cathode voxels at a second location on the X-Y plane are diluted with a second amount of a solvent, the second amount of the solvent being less than the first amount of the solvent.

9. The system of claim 8, wherein the first set of the plurality of cathode voxels are spaced from the second set of the plurality of cathode voxels along the X-Y plane.

10. The system of claim 8, wherein the first set of the plurality of cathode voxels at least partially overlap with the second set of the plurality of cathode voxels along the X-Y plane.

11. The system of claim 8, wherein the first set of the plurality of cathode voxels are diluted with the solvent in a range of 0-20% of the total composition of each voxel of the first set of the plurality of cathode voxels.

12. The system of claim 11, wherein the second set of the plurality of cathode voxels are diluted with the solvent in a range of 0-20% of the total composition of each voxel of the second set of the plurality of cathode voxels.

13. The system of claim 8, wherein the plurality of cathode voxels are configured for use in a battery system of an electric vehicle.

14. A method for creating a cathode electrode product for a battery system of an electric vehicle, the method comprising:
providing a donor foil;
providing a carrier substrate disposed adjacent the donor foil;
providing an optical system;
providing a current collector foil defined by an X-Y plane;
activating the optical system to generate a laser beam through the donor foil and the carrier substrate to create a plurality of cathode voxels; and
collecting the plurality of cathode voxels on the current collector foil.

15. The method of claim 14, wherein the plurality of cathode voxels includes a first set of cathode voxels and a second set of cathode voxels.

16. The method of claim 15, wherein the first set of the plurality of cathode voxels are spaced from the second set of the plurality of cathode voxels along the X-Y plane.

17. The method of claim 15, wherein the first set of the plurality of cathode voxels at least partially overlap with the second set of the plurality of cathode voxels along the X-Y plane.

18. The method of claim 15, wherein the first set of the plurality of cathode voxels are diluted with the solvent in a range of 0-20% of the total composition of each voxel of the first set of the plurality of cathode voxels.

19. The method of claim 18, wherein the second set of the plurality of cathode voxels are diluted with the solvent in a range of 0-20% of the total composition of each voxel of the second set of the plurality of cathode voxels.

20. The method of claim 14, wherein the plurality of cathode voxels are configured for use in a battery system of an electric vehicle.
